(19) United States
(12) Patent Application Publication
(10) Pub. No.: US 2021/0328297 A1
(43) Pub. Date: Oct. 21, 2021

(54) BATTERY FOR A MOTOR VEHICLE AND METHOD FOR PRODUCING A BATTERY FOR A MOTOR VEHICLE

(71) Applicant: AUDI AG, Ingolstadt (DE)

(72) Inventors: Michael HINTERBERGER, Großmehring (DE); Markus THURMEIER, Adlkofen (DE)

(73) Assignee: AUDI AG, Ingolstadt (DE)

(21) Appl. No.: 17/210,973

(22) Filed: Mar. 24, 2021

(30) Foreign Application Priority Data
Apr. 20, 2020 (DE) 102020110700.5

(51) Int. Cl. H01M 50/209; H01M 50/103; H01M 50/317; H01M 50/543

(52) U.S. Cl. CPC H01M 50/209; H01M 50/103; H01M 2220/20; H01M 50/543; H01M 50/317

(57) ABSTRACT

A battery for a motor vehicle, having multiple prismatic battery cells, which are arranged in a battery housing of the battery and each have two connections for electrically contacting the battery cell and a cell housing having an outflow opening, which is fluidically connected to an interior of the cell housing via a pressure relief valve and through which gas can be discharged from the interior. Each of the battery cells is overlapped by a separate formed plate part, which is arranged spaced apart from the respective outflow opening and, with the respective cell housing, encloses a flow space into which the outflow opening opens.

### FIELD

The invention relates to a battery for a motor vehicle, having multiple prismatic battery cells, which are arranged in a battery housing of the battery and each have two connections for electrically contacting the battery cell and a cell housing having an outflow opening, which is fluidically connected to an interior of the cell housing via a pressure relief valve and through which gas can be discharged from the interior. The invention furthermore relates to a method for producing a battery for a motor vehicle.

### BACKGROUND

Document DE 10 2018 207 331 A1, for example, is known from the prior art. This describes a storage cell for a storage device designed to store electrical energy for a motor vehicle, having a cell housing, which is formed cuboid on the outer circumference, and a receptacle space, two first walls delimiting the receptacle space along a first direction, two second walls delimiting the receptacle space along a second direction extending perpendicularly to the first direction, and two third walls delimiting the receptacle space along a third direction extending perpendicularly to the first direction and perpendicularly to the second direction, having storage means arranged in the receptacle space for storing electrical energy, and having laterally arranged connection elements via which the electrical energy stored by the storage means can be provided by the storage cell.

### SUMMARY

It is the object of the invention to propose a battery for a motor vehicle which has advantages over known batteries, in particular ensures greater operational reliability.

This object is achieved according to the invention by a battery for a motor vehicle. It is provided that each of the battery cells is overlapped by a separate formed plate part, which is arranged spaced apart from the respective outflow opening and, with the respective cell housing, encloses a flow space into which the outflow opening opens.

The battery is used to temporarily store electrical energy. For example, it forms part of the motor vehicle, but can also be provided separately from it. For example, the battery is designed as a traction battery of the motor vehicle and is thus used to provide electrical energy for operating a drive device of the motor vehicle. The drive device is in turn used to drive the motor vehicle, thus to provide a drive torque directed toward driving the motor vehicle. To generate the drive torque, the drive device has a drive unit which is in the form of an electrical machine and can also be referred to as a traction machine. The electrical machine is electrically connected to the battery, so that the electrical energy provided by the battery is used or can be used at least temporarily to operate the electrical machine.

The battery has the multiple battery cells to temporarily store the electrical energy. These are designed as prismatic battery cells so that the cell housings of the battery cell are cuboid or at least essentially cuboid. The battery cells are arranged in the battery housing of the battery. There is preferably a plurality of prismatic battery cells in the battery housing, which for this purpose are arranged adjacent to one another and, in particular, are fastened on the battery housing. Each of the battery cells has two electrical connections which are used to electrically contact the battery cell. The connections of all the battery cells of the battery are preferably electrically interconnected with one another. The battery itself therefore also has only two connections, for example, which are electrically connected to the connections of all the battery cells.

The cell housings of the battery cells are preferably rigid. Since pressure can build up in at least one of the battery cells during operation of the battery and in particular in case of a malfunction, the cell housings each have an outflow opening. In other words, such an outflow opening is formed in each of the cell housings. The outflow opening is fluidically connected to the interior of the respective cell housing via the pressure relief valve.

If a gas pressure in the interior exceeds a certain bursting pressure, the pressure relief valve thus opens and the gas can flow out of the interior of the cell housing via the pressure relief valve in the direction of the outflow opening and through this out of the cell housing. The bursting pressure of the pressure relief valve is selected in such a way that the pressure relief valve opens before mechanical damage to the cell housing occurs. The overpressure valve thus ensures that the overpressure present in the interior does not result in the cell housing bursting, which can cause mechanical damage in the surroundings of the corresponding battery cell and, in particular, damage to the other battery cells of the battery.

The pressure relief valve is designed, for example, as a bursting membrane or as a predetermined breaking point of the cell housing. Very basically, the pressure relief valve is thus to be understood as a device which only releases a flow connection between the interior and the outflow opening as soon as the internal pressure present in the interior of the cell housing exceeds the bursting pressure. For example, the pressure relief valve is designed in such a way that it permanently releases the flow connection when the bursting pressure is exceeded by the internal pressure. In this case, there is no provision for closing the pressure relief valve as soon as the internal pressure falls below the bursting pressure again.

Such a design of the battery or the battery cells ensures that the malfunction of one of the battery cells cannot result in mechanical damage to the other battery cells. The bursting pressure corresponds, for example, to at least 5 bar, at least 10 bar, or at least 15 bar. At the same time, it is at most 25 bar, at most 20 bar, or at most 15 bar.

The gas flowing out of the outflow opening after the pressure relief valve has been opened thus has the bursting pressure at least at the beginning. The gas can have a temperature of 1,000° C. or more. Based on these values, it is already clear that adjacent elements of the battery and, in particular, users of a motor vehicle, if the battery is installed therein, have to be protected from the influence of the gas. For example, it is provided that a fire protection plate is arranged over the battery in order to attenuate the kinetic energy of the gas escaping from the outflow opening and to prevent it from penetrating into the interior or the passenger area of the motor vehicle. However, such a fire protection plate is complex to integrate into the motor vehicle and also costly. Alternatively, the battery housing, in which the battery cells are arranged, could be made so solid that it withstands the gas flowing out of the outflow opening. However, this results in a high weight of the battery and also high costs.

For this reason, it is now provided that each of the battery cells is associated with a separate formed plate part which overlaps the outflow opening so that the gas flowing out of the outflow opening is deflected, in particular by at least 90°. In other words, there are multiple formed plate parts, wherein one of the formed plate parts is associated with each one of the battery cells and overlaps it. There are preferably as many formed plate parts as there are battery cells, wherein exactly one of the formed plate parts is associated with exactly one of the battery cells.

The formed plate part is arranged spaced apart from the outflow opening, but overlaps it. Correspondingly, the formed plate part forms the flow space with the respective cell housing. The outflow opening opens into this flow space. This means that the gas flowing out of the outflow opening first flows into the flow space and is then deflected by the formed plate part so that it subsequently flows parallel to a wall of the cell housing in which the outflow opening is formed.

The use of one formed plate part for each of the battery cells ensures excellent protection from the gas flowing out of the outflow opening. In addition, the formed plate part is producible easily, on the one hand, and inexpensively, on the other hand. The formed plate part is specifically to be understood as a plate part which is produced from plate by forming. For example, it is thus provided that a plate is to be provided, a plate part is to be stamped out of the plate, and then the plate part is to be formed into the formed plate part. The plate part can thus also be referred to as a stamped plate part. The resulting formed plate part is light, producible cost-effectively, and reliably protects from the gas flowing out of the outflow opening.

One refinement of the invention provides that the formed plate part has recesses which are penetrated by the connections of the respective battery cell, wherein the formed plate part has formed regions enclosing the recesses, in which the formed plate part is formed in the direction facing away from the cell housing. The connections preferably protrude beyond the cell housing. In order to enable electrical contacting of the battery cell or the connections, the formed plate part has the recesses. The connections of the battery cell protrude into these recesses.

It can be provided that the connections protrude beyond the formed plate part on the side facing away from the cell housing. However, it is particularly preferred that the connections terminate flush with the formed plate part on its side facing away from the cell housing. The connections are preferably each shaped cuboid or at least substantially cuboid. They are thus each delimited by four imaginary planes in the circumferential direction, wherein each two of the planes are parallel to one another. Each of the planes is perpendicular to two adjacent planes. However, the lateral surfaces of the connections do not have to merge into one another in a rectangular manner. Rather, it can be provided that lateral edges of the connections are rounded or provided with a chamfer.

Particularly preferably, the recesses are adapted in shape and/or dimensions to the connections. This is to be understood to mean that the recesses have the same shape and/or the same dimensions as the connections. Particularly preferably, after the formed plate part has been arranged on the respective battery cell, the edges bordering the recesses press against the connections, in particular in the circumferential direction by at least 50%, at least 75%, or completely and continuously. Particularly preferably, the formed plate part thus presses tightly against the connections, so that the gas cannot escape from the flow space between the connections and the edges delimiting the recesses.

Since the connections extend through the flow space up to the recesses, a flow cross-sectional area of the flow space is reduced in the region of the connections. In order to nevertheless enable the gas to flow past the connections with a sufficient mass flow or volume flow, the formed plate part has the formed regions. The formed regions enclose the recesses, for example the recesses are arranged centrally in the formed regions. In particular, each of the recesses is enclosed by one of the formed regions.

In the formed regions, the formed plate part is formed in such a way that its distance from the cell housing is greater than away from the formed regions. This ensures the availability of a sufficient flow cross-sectional area for the gas. The described design of the formed plate part thus enables the gas flowing out of the outflow opening to be reliably discharged, also past the connections. In addition, a negative influence on the connections by the gas is reliably prevented.

One refinement of the invention provides that the connections and the outflow opening are provided on an upper side of the battery cell, in particular the outflow opening is arranged between the connections. The upper side of the battery cell is understood to mean a side of the battery cell which, after the battery has been arranged as intended, is geodetically upwards. In principle, however, the connections and the outflow opening can be formed on any side, the upper side is only preferred with regard to its accessibility. The connections and the outflow opening could also be provided on a lower side or on a lateral surface of the battery cell.

In any case, however, the connections of the outflow opening are on the same side of the battery cell, in particular they are arranged on the same wall of the cell housing. This ensures, on the one hand, simple electrical contacting of the connections and, on the other hand, reliable and safe discharge of the gas through the outflow opening from the interior. It is particularly preferably provided that the outflow opening is located between the connections, in particular centrally. For example, a center point of the outflow opening and center points of the connections lie on an imaginary straight line. The arrangement of the outflow opening between the connections, in particular the central arrangement between the connections, enables the gas escaping from the interior to be discharged evenly.

One refinement of the invention provides that a central part lying between the formed regions and outer parts lying on opposite sides of the formed plate part lie in an imaginary plane and the formed regions are arranged at least in sections on the side of the plane facing away from the cell housing. In this respect, the formed plate part has at least the formed regions, the central part, and the outer parts. The formed regions are connected to one another via the central part. In this respect, the central part adjoins one of the formed regions, on the one hand, and another of the formed regions, on the other hand, preferably directly in each case.

One of the outer parts is provided on the side of each of the formed regions facing away from the central part. Particularly preferably, the formed regions, the central part, and the outer parts are made in one piece and of the same material. The central part and the outer parts are preferably flat throughout and lie in the imaginary plane. In contrast, the formed regions are arranged at least in sections on the side of the plane facing away from the cell housing, that is to say they are arranged farther away from the cell housing than the plane and therefore the central part and the outer parts. With such an embodiment of the formed plate part, a sufficient flow cross-sectional area for the gas is created in the region of the connections.

One refinement of the invention provides that the recesses are formed in a first wall of the formed plate part from which at least one second wall, angled with respect to the first wall, extends which engages between two of the battery cells. The first wall here has, for example, the formed regions, the central part, and the outer parts. The at least one second wall extends from the first wall, namely at an angle which is greater than 0° and less than 180°. The angle between the first wall and the second wall is preferably between 75° and 105°, between 80° and 100°, between 85° and 95°, or approximately or exactly 90°.

After the battery has been installed, the second wall engages between two of the battery cells. For example, the second wall extends as far as a bottom of the battery housing, that is to say it completely overlaps the battery cells in the direction of the bottom. This creates a separation of the individual battery cells from one another. In this way, thermal isolation of the battery cells from one another can also be achieved.

The formed plate part particularly preferably has multiple second walls, in particular two second walls, each of which extends from the first wall. Here, the two second walls extend from the first wall on opposite sides of the latter. In other words, the second walls engage on the first wall spaced apart from one another. Starting from the first wall, the second walls preferably extend in the same direction, namely in particular in the direction of the bottom of the battery housing. For example, the two walls are arranged parallel or at least substantially parallel to one another. After the battery has been installed, the second walls of adjacent formed plate parts thus press against one another. As a result, the formed plate parts are reliably fixed within the battery housing.

One refinement of the invention provides that at least one formfitting device is formed on the second wall, which interacts with a formfitting counter-device of the battery housing to hold the formed plate part on the battery housing. The formfitting device is used to fasten the formed plate part on and/or in the battery housing. For example, the formfitting device is in the form of a formfitting projection, whereas the formfitting counter-device is designed as a formfitting receptacle. For example, the formfitting device or the formfitting projection is hook-shaped, so that the formed plate part can be suspended in the battery housing.

The second wall preferably has multiple such formfitting devices which are arranged spaced apart from one another, in particular uniformly spaced apart from one another. Particularly preferably, every second wall has the at least one formfitting device, for example multiple formfitting devices. For example, the second wall has at least one such formfitting device in each case on opposite sides. Such an embodiment ensures reliable fastening of the formed plate part on the battery housing.

One refinement of the invention provides that the formed plate part has at least one third wall which extends from the first wall and is angled with respect to the first wall, wherein the third wall is also angled with respect to the second wall, in particular presses against the second wall while forming an angle. The third wall is preferably made in one piece with and of the same material as the first wall. It extends from the first wall and forms an angle with it which is greater than 0° and less than 180°. For example, the angle is at least 75° and at most 105°, at least 80° and at most 100°, at least 85° and at most 95°, or approximately or exactly 90°. Moreover, the same applies to the angle between the third wall and the second wall.

Particularly preferably, the second wall and the third wall each extend in the same direction starting from the first wall, namely in particular in the direction of the bottom of the battery housing. It can be provided that the formed plate part has multiple third walls. These are preferably each designed in accordance with the statements made in the context of this description. For example, the third walls are arranged on opposite sides of the first wall or extend therefrom on opposite sides of the first wall. For example, a first of the third walls extends from a first of the outer parts and is arranged spaced apart from the respective other of the outer parts. A second of the third walls, on the other hand, extends from another one of the outer parts and is arranged spaced apart from the one of the outer parts.

If, in addition to the first wall, the formed plate part has both multiple second walls and multiple third walls, it thus preferably receives the cell housing completely therein. For this purpose, the third wall particularly preferably presses against the second wall, for example it runs into it while forming an angle. The angle here is again greater than 0° and less than 180°, it is preferably in one of the above-mentioned angle ranges. The embodiment described enables particularly effective protection of the battery cell because the battery cells are at least mechanically, but preferably also thermally, isolated from one another.

One refinement of the invention provides that, starting from the wall, the third wall extends in the same direction as the second wall, in particular has a smaller extension in this direction than the second wall. This particularly preferably applies to each of the third walls if there are multiple third walls. For example, starting from the first wall, the second walls have the same extension and also extend in the same direction. The at least one third wall extends in the same direction as the second wall, that is to say preferably in the direction of the bottom of the battery housing. Here it can have the same extension as the second wall. Alternatively, its extension is smaller. In the case of the last-mentioned embodiment, an outlet opening is created for the gas from the formed plate part. In any case, the described formed plate part enables particularly reliable protection of the respective battery cell.

One refinement of the invention provides that the first wall, the at least one second wall, and the at least one third wall are made in one piece and of the same material and are produced by forming a plate. The formed plate part is therefore not only partially produced by forming, but rather, the first wall, the at least one second wall, and the at least one third wall are all implemented by means of forming. This enables a particularly cost-effective design or production of the formed plate part. The plate is preferably a metal plate, for example a steel plate. The metal sheet can be provided with an insulation layer, which effectuates thermal insulation of the battery cells from one another. For this purpose, the insulation layer has, for example, a lower thermal conductivity than the plate. However, the plate can also consist of a non-metal, for example a plastic. This also makes it possible to achieve the mechanical isolation of the battery cells in an advantageous manner. This also applies to the thermal insulation of the battery cells from one another.

The invention furthermore relates to a method for producing a battery for a motor vehicle, in particular a battery according to the embodiment in the context of this description, wherein the battery has multiple prismatic battery cells which are arranged in a battery housing of the battery and each have two connections for electrically contacting the battery cell and a cell housing having an outflow opening, which are fluidically connected to an interior of the cell housing via a pressure relief valve and through which gas can be discharged from the interior. It is provided that each of the battery cells is associated with a separate formed plate part overlapping it, which is arranged spaced apart from the respective outflow opening and encloses a flow space with the respective cell housing, into which the outflow opening opens.

The advantages of such an embodiment of the battery and of such a procedure have already been discussed. Both the battery and also the method for its production can be refined according to the embodiments within the scope of this description, to which reference will therefore be made.

### BRIEF DESCRIPTION OF THE FIGURES

In the following, the invention will be explained in greater detail with reference to the exemplary embodiments depicted in the drawings, without this restricting the invention. In the figures:

FIG. 1 shows a schematic illustration of a region of a battery for a motor vehicle, wherein a battery cell and a formed plate part enclosing the battery cell are shown,

FIG. 2 shows a schematic sectional illustration through the battery cell and the formed plate part, and

FIG. 3 shows a schematic illustration of a production process of the formed plate part.

### DETAILED DESCRIPTION

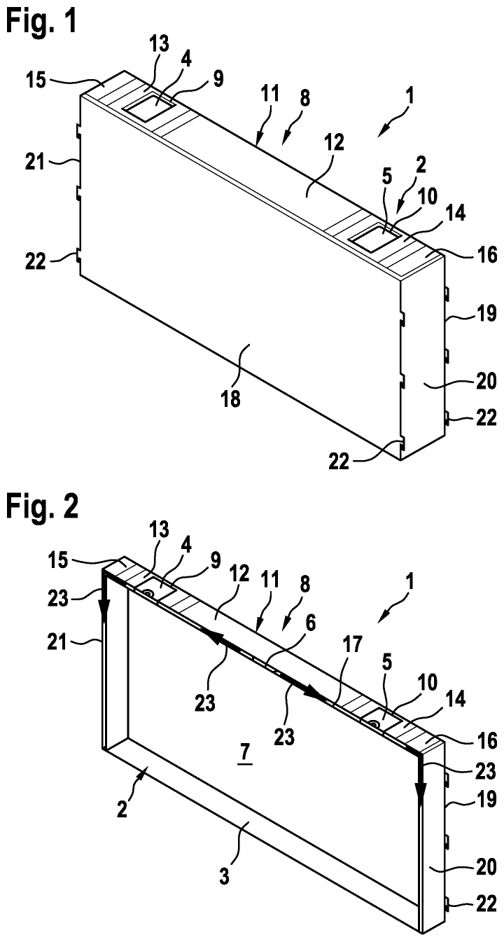

FIG. 1 shows a schematic illustration of a region of a battery 1 which is provided and designed for installation in a motor vehicle. The battery 1 has multiple prismatic battery cells 2, only one of which is shown here. The battery cell 2 has a cell housing 3, which cannot be seen here, on which two connections 4 and 5 are formed. The connections 4 and 5 are used to electrically contact the battery cell 2. The cell housing 3 has an outflow opening 6 (which cannot be seen) which is fluidically connected to an interior 7 of the cell housing 3 via a pressure relief valve.

The battery cell 2 is overlapped by a formed plate part 8. The formed plate part 8 has recesses 9 and 10 into which the connections 4 and 5 protrude. The recesses 9 are formed in a first wall 10 of the formed plate part 8. The first wall 11 has a central part 12, two formed regions 13 and 14, and two outer parts 15 and 16. The central part 12 is located centrally between the formed regions 13 and 14, in which the recesses 9 and 10 are formed. The outer parts 15 and 16 adjoin each of the formed regions 13 and 14 on the side thereof facing away from the central part 12.

It can be seen that the first wall 11 is formed in the formed regions 13 and 14 in the direction facing away from the cell housing 3. As a result, a flow cross-sectional area of a flow space 17 (not visible), which is delimited jointly by the cell housing 3 and the formed plate part 8, in particular on a first wall 11, is enlarged. In addition to the first wall 11, the formed plate part 8 has at least one second wall 18, in the exemplary embodiment shown here, two second walls 18 and 19. In addition, it has at least one third wall 20, here for example two third walls 20 and 21.

The second walls 18 and 19 and the third walls 20 and 21 each extend from the first wall 11 and protrude in the same direction. In the exemplary embodiment shown here, the second walls 18 and 19 and the third walls 20 and 21 each have the same extension in the direction facing away from the first wall 11. They thus terminate flush with one another on their side facing away from the first wall 11. Multiple formfitting devices 22 are formed on each of the second walls 18 and 19, only a few of which are identified here by way of example. The formfitting devices 22 are used to fasten the formed plate part 8 in a battery housing of the battery 1. For this purpose, they cooperate with formfitting counter-devices of the battery housing.

FIG. 2 shows a schematic sectional illustration of the battery 1. The flow space 17, which is delimited on the one hand by the cell housing 3 and on the other hand by the formed plate part 8, can now be clearly seen. The plate part 8, in particular its first wall 11, overlaps the outflow opening 6 here. Gas flowing out of the interior 7 through the outflow opening 6 is deflected by the formed plate part 8 and discharged in the direction of the arrows 23. Since the first wall 11 in the formed regions 13 and 14 is at a greater distance from the cell housing 3 than away from the formed regions 13 and 14, a flow cross-sectional area of the flow space 17 is also achieved in the area of the connections 4 and 5, which is sufficient to discharge the gas with the desired mass flow or volume flow. A widening of the flow space 17 by the formed regions 13 and 14 is preferably designed in such a way that the flow space 17 has the same flow cross-sectional area adjacent to the connections 4 and 5 as it does away from the connections 4 and 5.

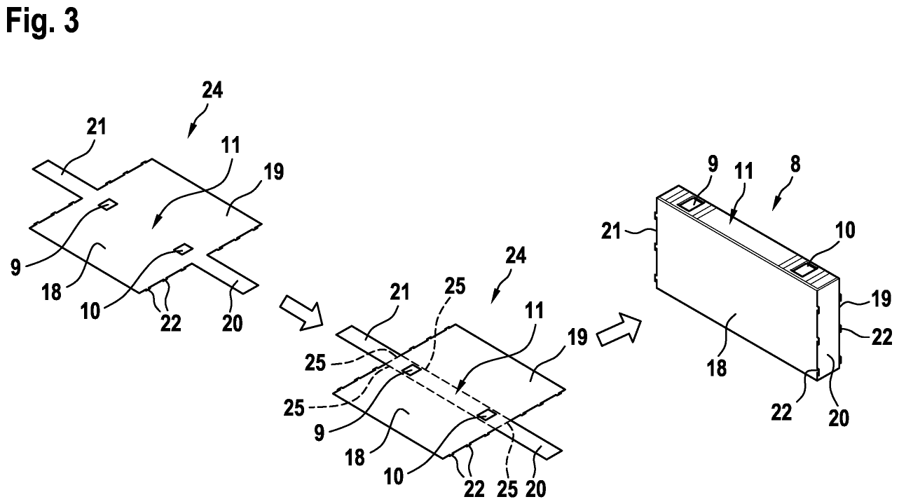

FIG. 3 shows a schematic illustration of a production process of the formed plate part 8. First, a plate (not shown in greater detail here) is provided and subjected to a stamping process, so that a plate part 24 is provided. In this plate part 24, for example, beads 25 are subsequently introduced in order to enable simple forming of the second walls 18 and 19 and the third walls 20 and 21 with respect to the first wall 11. The second walls 18 and 19 and the third walls 20 and 21 are then bent over with respect to the first wall 11 in order to finally form the plate part 8. The procedure described ensures simple and inexpensive production of the formed plate part 8 and the battery 1.

### LIST OF REFERENCE SIGNS

1 battery
2 battery cell
3 cell housing
4 connection
5 connection
6 discharge opening
7 interior
8 formed plate part
9 recess
10 recess
11 first wall
12 central part
13 formed region
14 formed region
15 outer part
16 outer part
17 flow space
18 second wall
19 second wall
20 third wall
21 third wall
22 formfitting device

1. A battery for a motor vehicle, comprising: multiple prismatic battery cells which are arranged in a battery housing of the battery and each have two connections for electrically contacting the battery cell and a cell housing having an outflow opening which is fluidically connected to an interior of the cell housing via a pressure relief valve and through which gas can be discharged from the interior, wherein each of the battery cells is overlapped by a separate formed sheet metal part which is arranged spaced apart from the respective outflow opening and, with the respective cell housing, encloses a flow space into which the outflow opening opens.

2. The battery according to claim 1, wherein the formed sheet metal part has recesses which are penetrated by the connections of the respective battery cell, wherein the formed sheet metal part has formed regions enclosing the recesses, in which the formed sheet metal part is formed in the direction facing away from the cell housing.

3. The battery according claim 1, wherein the connections and the outflow opening are provided on an upper side of the battery cell.

4. The battery according to claim 1, wherein a central part lying between the formed regions and outer parts lying on opposite sides of the formed plate part lie in an imaginary plane and the formed regions are arranged at least in sections on the side of the plane facing away from the cell housing.

5. The battery according to claim 1, wherein the recesses are formed in a first wall of the formed sheet metal part, from which at least one second wall angled with respect to the first wall extends, which engages between two of the battery cells.

6. The battery according to claim 1, wherein at least one formfitting device is formed on the second wall, which device cooperates with a formfitting counter-device of the battery housing to hold the formed sheet metal part on the battery housing.

7. The battery according to claim 1, wherein the sheet metal part has at least one third wall which extends from the first wall and is angled with respect to the first wall, wherein the third wall is also angled with respect to the second wall.

8. The battery according to claim 1, wherein the third wall, starting from the first wall, extends in the same direction as the second wall.

9. The battery according to claim 1, wherein the first wall, the at least one second wall, and the at least one third wall are made in one piece and of the same material and are produced by forming a plate.

10. A method for producing a battery for a motor vehicle wherein the battery has multiple prismatic battery cells which are arranged in a battery housing of the battery and each have two connections for electrically contacting the battery cell and a cell housing having an outflow opening which is fluidically connected to an interior of the cell housing via a pressure relief valve and through which gas can be discharged from the interior, wherein each of the battery cells is associated with an overlapping, separate formed sheet metal part which is arranged spaced apart from the respective outflow opening and, with the respective cell housing, encloses a flow space into which the outflow opening opens.

11. The battery according claim 2, wherein the connections and the outflow opening are provided on an upper side of the battery cell.

12. The battery according to claim 2, wherein a central part lying between the formed regions and outer parts lying on opposite sides of the formed plate part lie in an imaginary plane and the formed regions are arranged at least in sections on the side of the plane facing away from the cell housing.

13. The battery according to claim 3, wherein a central part lying between the formed regions and outer parts lying on opposite sides of the formed plate part lie in an imaginary plane and the formed regions are arranged at least in sections on the side of the plane facing away from the cell housing.

14. The battery according to claim 2, wherein the recesses are formed in a first wall of the formed sheet metal part, from which at least one second wall angled with respect to the first wall extends, which engages between two of the battery cells.

15. The battery according to claim 3, wherein the recesses are formed in a first wall of the formed sheet metal part, from which at least one second wall angled with respect to the first wall extends, which engages between two of the battery cells.

16. The battery according to claim 4, wherein the recesses are formed in a first wall of the formed sheet metal part, from which at least one second wall angled with respect to the first wall extends, which engages between two of the battery cells.

17. The battery according to claim 2, wherein at least one formfitting device is formed on the second wall, which device cooperates with a formfitting counter-device of the battery housing to hold the formed sheet metal part on the battery housing.

18. The battery according to claim 3, wherein at least one formfitting device is formed on the second wall, which device cooperates with a formfitting counter-device of the battery housing to hold the formed sheet metal part on the battery housing.

19. The battery according to claim 4, wherein at least one formfitting device is formed on the second wall, which device cooperates with a formfitting counter-device of the battery housing to hold the formed sheet metal part on the battery housing.

20. The battery according to claim 5, wherein at least one formfitting device is formed on the second wall, which device cooperates with a formfitting counter-device of the battery housing to hold the formed sheet metal part on the battery housing.
